(19) United States
(12) Patent Application Publication
(10) Pub. No.: US 2011/0093316 A1
(43) Pub. Date: Apr. 21, 2011

(54) SYSTEM AND METHOD OF PROMOTING, OPERATING, AND MANAGING AN INTERACTIVE DIGITAL CONTENT DOWNLOAD KIOSK

(76) Inventors: Brian A.D. Baker, Cleveland, OH (US); John Roberts, III, Euclid, OH (US)

(21) Appl. No.: 12/906,973

(22) Filed: Oct. 18, 2010

Related U.S. Application Data
(60) Provisional application No. 61/279,059, filed on Oct. 16, 2009.

(51) Int. Cl. G06Q 30/00

(52) U.S. Cl. 705/14.4

(57) ABSTRACT

The present application operates a kiosk which presents multimedia advertising and sells downloads of multimedia content. A user is attracted by displayed video/audio advertising, prompted to make a selection, choices are stored in a shopping cart, and proper payment means are received. The system leverages off of relationships between downloaded sales and multimedia advertising to cross-sell various media products such as music, movies, books, games and the like. The entire system is self-contained, does not require the presences of an operator or cashier, and is able to back itself up nightly through internet connectivity.

This application claims priority to U.S. Provisional Patent Application Ser. No. 61/279,059, filed Oct. 16, 2009. The disclosure of this application is hereby fully incorporated by reference in its entirety.

### BACKGROUND

The present disclosure relates to interactive sales of multimedia content and kiosks and systems for making such sales.

Many types of information are available for digital download. Books, music, films and television programs may all be retrieved off of the Internet. Some models are fee-based while others are for free. Such media data, when downloaded may be stored on a variety of media. The primary means of download is the personal computer, either at a network web based terminal, in a wireless laptop computer environment, or in a portable personal assistant.

The technology in this area is reliant upon access to a computer network, either through a direct wired interface or in a wireless environment. The hard wired interface offers the benefit of faster transmission speeds and security. The wireless environment offers the advantage of portability, which lends itself to more frequent and impulse based usage. However, the wireless environment suffers the disadvantage of sporadic access based on coverage areas and signal strength. Wireless also may permit reception or interception of the signal by unauthorized users.

Technology in this area has made great strides in promoting network security through the use of password protection, identity card implementation, and dedicated debit cards.

What is needed in the art is a truly stand-alone system that offers the advantage of security, availability, payment verification, and self promotion which generates impulse or spontaneous sales. The present application presents such a system and method.

### BRIEF DESCRIPTION

The present application discloses a music and multimedia content promotion and distribution system for integrating kiosk hardware and computer software. The hardware is comprised of a networked computer, a database of stored downloaded content, a payment verification system and a display terminal for displaying promotional and advertising content. The computer software comprises a means for user identification and payment verification, for searching and selecting specific music from a catalog of choices, for providing accounting and maintenance of records to document the number of downloads, for playing the media content that has been chosen for preview, and for purchase.

The present application also discloses a method of operating and managing a kiosk for multimedia content promotion and distribution. The method provides a display for continuous advertisement of music, video, or gaming content, facilitates searches for music, enables user selection of particular music, provides digital content download capabilities, and provides for payment options.

Disclosed in some embodiments is an interactive digital content download kiosk, comprising: an internal database of stored audio/video data; a network interface for the transmission of data between the internal database and a remote server; a user interface to request data from the internal database; a payment means for receiving payments; a downloading means to transfer data from the internal database and into an associated user device; an administrator means to control access to the internal database; a timer routine for scheduling kiosk activities; a reporting routine for generating kiosk usage reports; an advertising interface for the transmission of advertisements; and a computer operable processor to operate the kiosk.

Disclosed in some embodiments is a system for managing a plurality of interactive digital content download kiosks, comprising: a central computer database; a plurality of kiosks, each kiosk comprising: an internal database of stored audio/video data; a network interface for the transmission of data between the internal database and a remote server; a user interface to request data from the internal database; a payment means for receiving payments; a downloading means to transfer data from the internal database and into an associated user device; an administrator means to control access to the internal database; a timer routine for scheduling kiosk activities; a reporting routine for generating kiosk usage reports; an advertising interface for the transmission of advertisements; and a computer operable processor to operate the kiosk; and data connections from the central computer database to each kiosk.

### BRIEF DESCRIPTION OF THE DRAWINGS

FIG. 1 is a schematic of the integrated system.

FIG. 2 is an illustration of the multiple terminal kiosk arrangement.

FIG. 3 is an illustration of one specific terminal in the kiosk.

FIG. 4 is a screen shot of the Administrator terminal.

FIG. 5 is a flowchart of a transaction.

FIG. 6 is a flowchart of the evening system backup.

FIG. 7 is an illustration of the introduction screen.

FIG. 8 is an illustration of the “select your device” screen.

FIG. 9 is an illustration of the search screen.

FIG. 10 is an illustration of the retrieved artist screen from a search.

FIG. 11 is an illustration of the album search result.

FIG. 12 is an illustration of the specific album sampling and track listing screen.

FIG. 13 is an illustration of the shopping cart.

FIG. 14 is an illustration of the method of payment screen.

FIG. 15 is an illustration of the step-by-step process.

### DETAILED DESCRIPTION

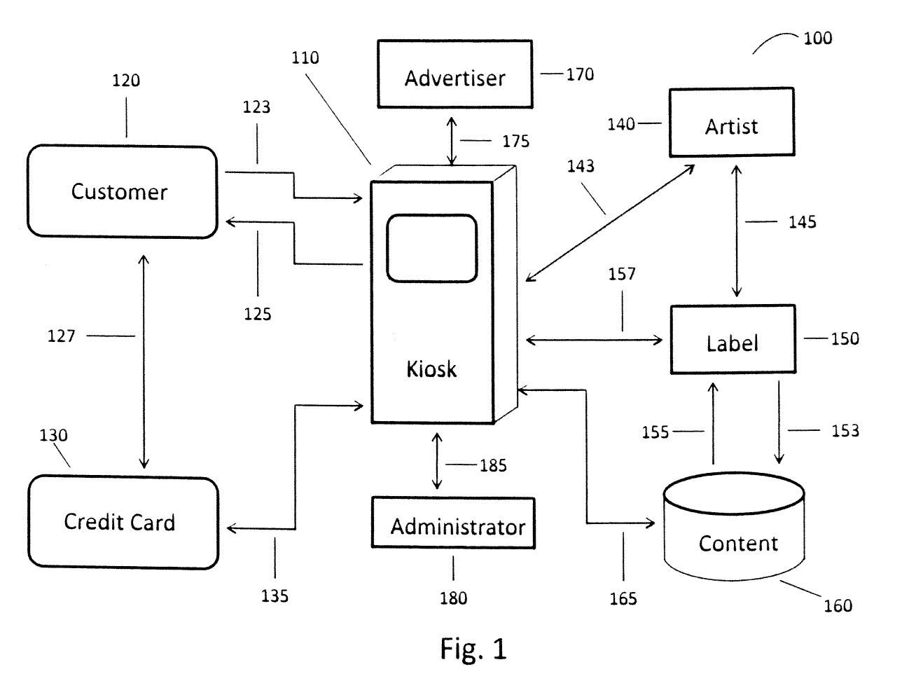

FIG. 1 provides a layout of the numerous components of the present system 100. The kiosk 110 is a hardware component comprised of a video display terminal, user interface, and means to link the kiosk to the Internet.

The kiosk contains a computer processor to facilitate the transmission of audio signals in either a compressed or a real time bit transfer rate. Input to the system is by means of a keyboard which will allow the user to interact with the system by making selections of music such as artist name, song title, album title, and the like. Input may also include a scanner or voice recognition software. An input card reader will also be available to read credit or debit cards. A network interface including a network card, an input terminal, and an electric plug will be integrated in order to allow information and input to be received by the system.

The kiosk will also contain output means to convey information to the user. A video terminal will convey visual advertising and promotion information. Audio speakers will convey sound such as music or advertising to the user. A set of headphones will allow a user to be the exclusive listener to a sample of the music to be purchased. A serial output port will enable a user to plug in a personal device, such as an iPod or a jump drive, in order to receive the music content purchased. Finally, a printer will be available to print out a paper receipt in a hard copy format.

The kiosk may stand alone, or any number of terminals may be attached together as a series of kiosk terminals, either in a linear fashion or in a circular or rectangular pattern.

The kiosk contains software to facilitate the selection, promotion and management of music content. The kiosk is linked to and provides an interface for the customer 120 such that the customer 120 may enter data 123 such as a request for content and send this request to the kiosk 110. In response, the kiosk system returns the content 125 that most closely matches the user requested search.

The system 100 is also linked to a payment system 130 such as a credit card, a debit card, or a prepaid card system. The customer 120 can check the status 127 of the card, such as the remaining balance on the debit card, through interaction through the kiosk. The card 130 interacts 135 with the kiosk to verify payment and validate the authentication of the user via a user ID and/or password system.

The system 100 also interacts with the artist/content creator 140 either directly 143 or through an intermediary such as a record label, sound scan, ASCAP, BMI and the like. Such interaction may include deposit of the media content into the kiosk or receiving data regarding sales, views, and hits on the user initiated searches.

This process may also be performed by a professional record label 150 which would edit and manage the content submitted 145 by the artist 140 and give the artist information on performance of the content, including transfer of money revenue generated by the content. The music 160 or other content would be deposited 153 onto and reside on a separate database 160 present in the kiosk. Content could also be removed 155 for editing or as a limited time offer promotion, or for legal or other marketing rationale. The content could then be accessed 165 directly by the kiosk and the label could receive performance reports 155 related to the use of the content by users 120 of the kiosk.

Additional revenue may be generated by integration of an advertiser 170 such as an advertising agency, a record label promotion department, a commercial entity on whose property the kiosk is located, and the like. The advertiser 170 could add 175 content for video display on the kiosk and receive verification of how often and when the advertising was displayed.

A central administrator 180 would be the final arbitrator in governing what content is displayed, which party has specific access, and the transfer of monies as a result of the operation of the kiosk.

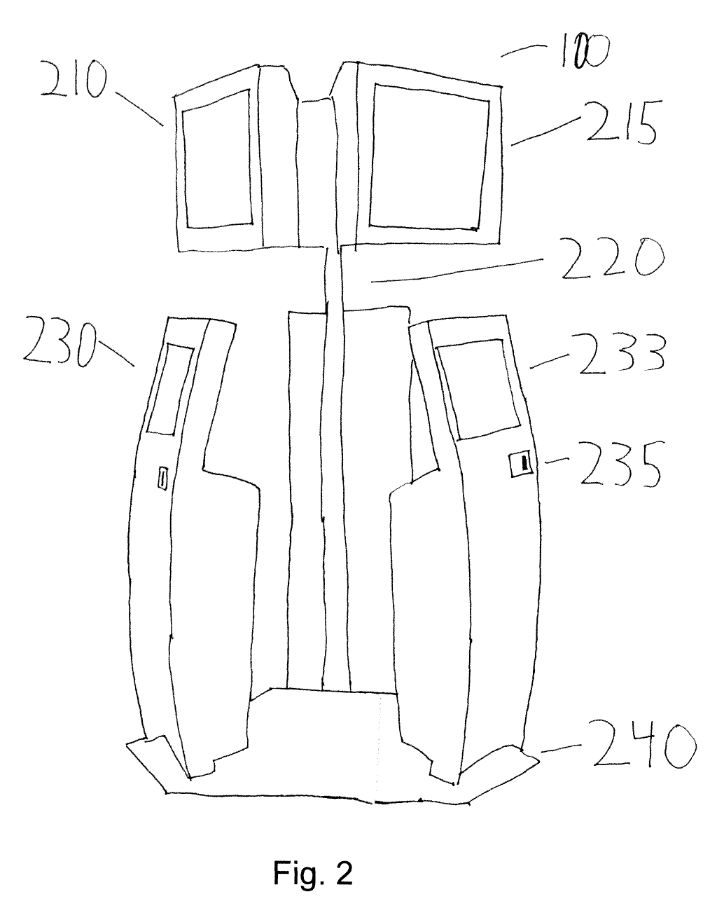

FIG. 2 presents an illustration of the system 100 and component parts. One or more display units, such as a video monitor 210 or television screen 215, sit above the kiosk(s) 230 and display audio/video content to attract potential customers. The display unit(s) may also promote specific artists or cross promote related downloads such as films, video games related to artists, etc. The display units could also display content not related to music or entertainment, such as vendors at the retail space where the kiosk system is located. The monitors 210, 215 are mounted on a support column 220 and attached to a solid base 240. Arranged around the support column are the individual kiosks 230, which are placed back to back in an arrangement on the base 240. The illustrated embodiment shows three kiosks 230 and three monitors 210, but any number of kiosks may be arranged. The number of monitors and kiosks can vary independently. In embodiments, the ratio of monitors to kiosks is 1:1. Each kiosk has a video display 233 and a means for user input 235, such as a keyboard or touch screen.

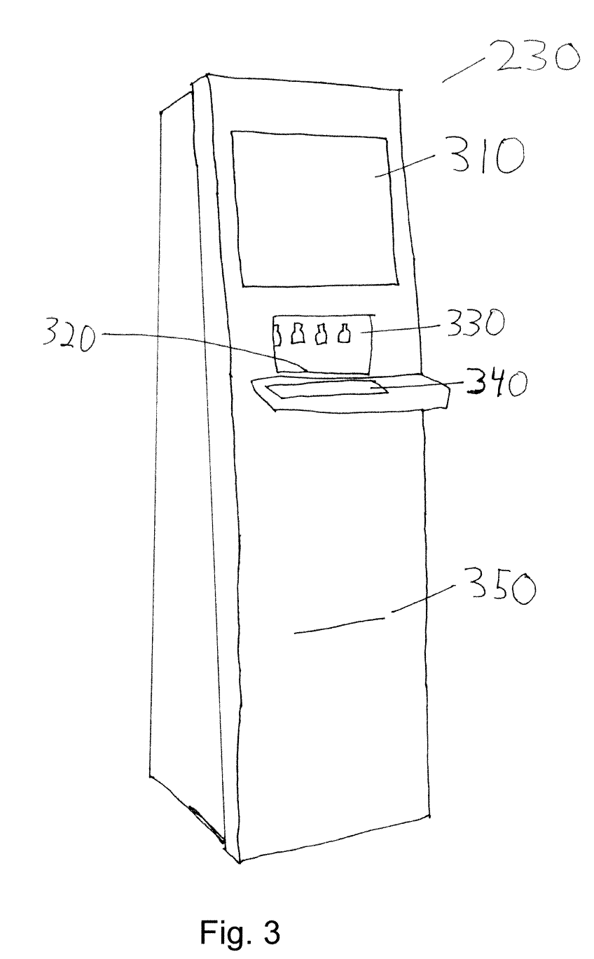

FIG. 3 presents a detailed view of the kiosk 230. It comprises a video display 310 where the music, video, or other content choices are presented. The kiosk 230 also includes a downloading means 330, such as a USB port, for attaching the device to which the content is to be downloaded. A user interface 340, such as a keyboard with mouse or trackball, is also attached to facilitate user interaction and customer input. A flat area 320 for resting a laptop, personal data assistant, or iPod® is also presented.

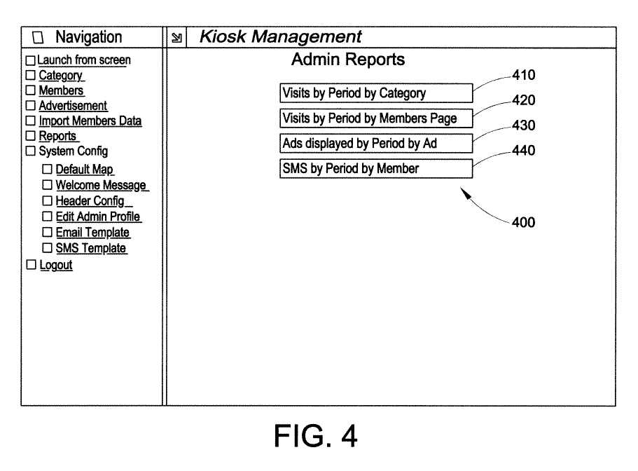

FIG. 4 represents a graphical user interface for the administrator 180 which interacts 185 with the kiosk 110. Here, a full display 400 of features is presented. “visits by period by category” 410 shows visits by the customer according to the style of music. “visiting by period by members” 420 shows visits by preferred members evaluated by music type. “ad displays” 430 presents the advertising agency with proof the ads they purchased were run and when run. “SMS by period by member” 440 is indeterminate.

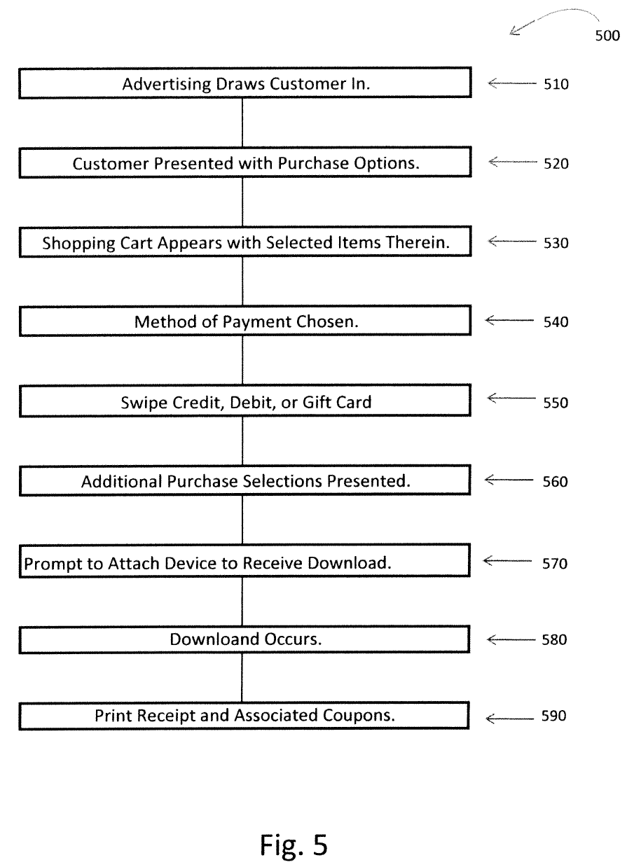

FIG. 5 illustrates a transaction wherein the user interacts with the kiosk. The transaction is one of the many key components to the functionalities of the kiosk 110. This component may transpire in several ways. The user interacts with the kiosk, through browsing, listening to snippets of music, or taking part in watching music videos/advertisement 510. The user is presented with purchase options 520. For example, the user may choose by song or choose an entire album from their favorite artist. For example, a fan of The Beatles could purchase a song for $0.89 or get the entire Abbey Road album for $7.99. A shopping cart appears to let the user know the quantity of music they are adding 530. The price appears to show the user how much their selections cost at that time. When the user decides to make a purchase, the monitor prompts the user to choose a method of payment 540, for example using a credit card, debit card, or gift card.

Once the user has made a choice, the user swipes 550 the card into a card reader in the kiosk. The kiosk accesses the information on the card and authorizes the purchase. During this process, the monitor prompts the user with additional purchase selections like “Does this complete your purchase?” or “Would you like to purchase other related artist or music?” 560. For example, a user who has selected The Beatles album “Abbey Road” could then be presented with “The Beatles White Album.” The monitor gives the user a choice of “Yes” or “No”. If the user chooses “No”, then the kiosk will continue the authorization for only the Abbey Road album. The user is prompted to attach a user device 570 on which to download the selected media content. The download of content occurs 580. Once download is complete, the kiosk notifies the user and then prints out a receipt 590, optionally along with coupons from other retailers in the location in which the kiosk is located. For privacy protection, the kiosk may include a motion sensor that signals the machine when the user has moved away from a specified location. The kiosk can then reset itself automatically. This way, a user who rushes away without logging out will be automatically logged out, securing their information from the next person waiting to use the kiosk. A timer routine may be used to log the user off automatically after a given time period and reset the kiosk for the next person to use.

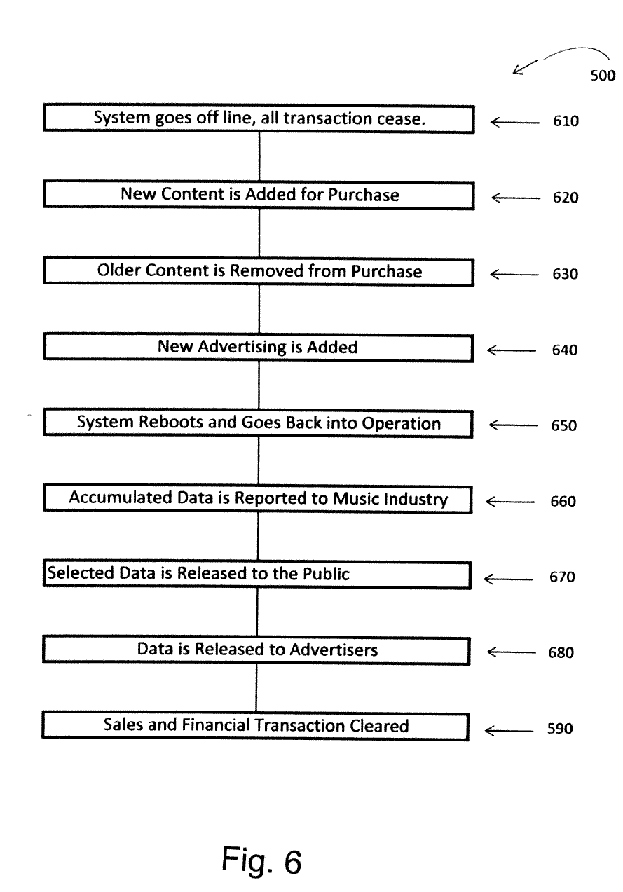

FIG. 6 presents a flowchart showing automated operations of the kiosk at the end of a working day. For example, a shopping mall may operate during normal business hours from 10:00 am to 9:00 pm Monday thru Saturday and from 12:00 noon to 6:00 pm on Sundays. Each kiosk may be placed on a timer routine that automatically shuts down 610 the kiosk when the shopping mall is closed. The timer routine can be programmed independently for each day. It is contemplated that kiosks may be located in several different locations and time zones, and that all of the kiosks can be centrally managed from one or a few central locations.

When the kiosk location is closed and shutdown occurs, an open window of time is available for a centralized analyst to update the system by adding new music or content 620, removing old content 630, and adding new advertisements 640. For example, new music releases typically occur on Tuesdays. Thus, once a week on Mondays at 11 pm, the system can automatically update with new music. The kiosk software may be programmed to update itself (“pull” the new information), depending on how effective or time consuming that may be.

Once the system has been updated, the kiosk can automatically reboot 650, and is then ready for operation on the next business day. The time period in which the system is shut down should be as short as possible. For example, in locations that are usually open 24 hours a day (airports, bus stations, Amtrak stations, etc.), the system may shut down for only 30 minutes each day so that potential customers are not disappointed. Companies operating the kiosk would want their customers' experience to be rewarding and easy.

A backup and update process is vital in the operation of the kiosk. Proper upkeep and maintenance is one of many keys to the success of the kiosk.

A reporting routine may be used with the kiosk. For example, each kiosk can generate a report of how well the kiosk is performing in a course of a day, week, and a month. The report might consist of how many people logged on and interacted with the kiosk, the amount of time spent by each user, what content was purchased, and the quantity of purchases. The data accumulated can formatted in a report that is provided periodically to interested parties such as investors, music industry executives, Soundscan, Billboard, or distributors 660. Selected data could be released to the public 670.

All such reports can be categorized and used to promote advertising 680. This gives corporate entities the opportunity to expand their product visibility. For example, if each kiosk displays advertisements to 10,000 customers a day, this would translate to roughly 300,000 monthly interactions with the kiosk. Sales can be tabulated and used to determine revenue allocation 590 and funds can then be assigned to the proper financial accounts. The system now may be employed to promote sales, marketing, and advertisements, as well as perform as a network that may broadcast from a national spectrum to a global conglomerate.

The process by which a customer interacts with the system can be described as follows. A customer with an iPod may pass by the kiosk. The customer notices the monitor playing a popular video and is attracted to the kiosk. The monitor is attached to a kiosk. The kiosk has multiple sides and may contain blank space to post advertising messages. A user approaches the kiosk, picks up a set of headsets, and begins to follow the directions that will appear on a touch screen. For example, the following prompts may appear:

1. Touch your genre selection of music—selections may include pop, country, rock, rap, pop, R&B, jazz and classical, to show a variety of music.

2. Choose your artist—a list of artists is shown.

3. Would you like to listen or purchase?

4. Select your tunes—show the album(s) of the selected artist,

5. Show a prompt for ‘single’ or ‘full album’.

6. Select your method of payment—Visa, Master Card, PayPal, etc.

7. Insert your method of payment.

8. Payment accepted. You may now plug in your iPod and download your selection.

In an alternate embodiment, the customer may plug in their device, such as an iPod®, prior to requesting music or at any time prior to purchase. The user may also provide the headphones necessary to preview the media content the customer is interested in purchasing.

While the iPod® is plugged into the kiosk, the monitor may display entertaining graphics for a number of seconds as the transaction is performed. Once the transaction is complete, the user is prompted to make another selection. “Yes” or “No” should come onto the screen as available responses. If the user chooses “Yes”, then the process is repeated. If the user chooses “No”, then a prompt to unplug the iPod® is sent, a receipt is printed, and a ‘Thank You’ message pops up on the screen.

The download process many also be performed with a jump-drive, which may be purchased from the kiosk.

Once the purchase has been made, the transaction information can go automatically to a processing center provided by a centralized entity. Relevant funds can be controlled by the centralized entity, where for example an accounting firm or financial managers may put together a series of accounts to which funds are then allocated.

The company operating the kiosk may also partner with an established music retailer, label, or established digital distributor such as Apple®, to enable the kiosk to access a greater variety of songs.

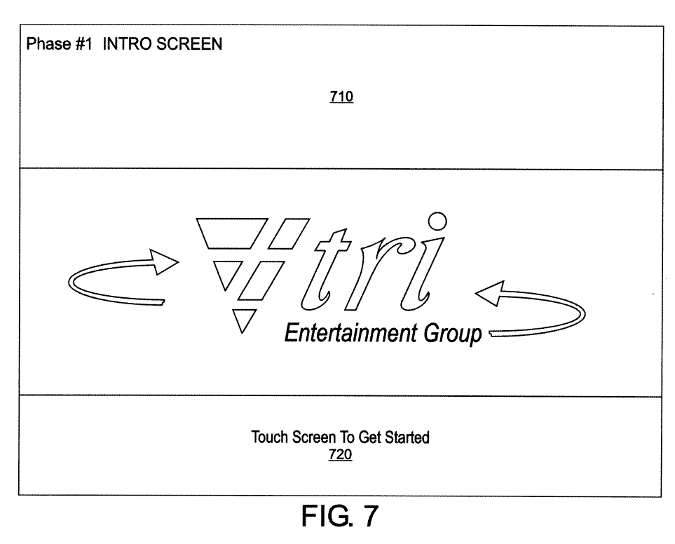

FIG. 7 presents the introduction screen that will be displayed once the user walks up to the device prior to any activity being engaged in by the user. A message will be displayed featuring the company logo 710, below that 720 will be a message stating touch screen to get started.

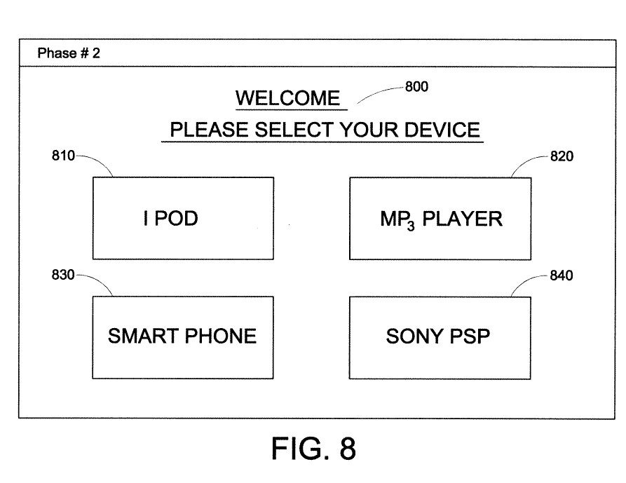

FIG. 8 presents a welcome screen that gives the user a choice of formats with which music may be downloaded. The user may choose from a list including, but not limited to, an iPod 810, an MP3 player 820, a Smart Phone 830, or a Sony PSP 840.

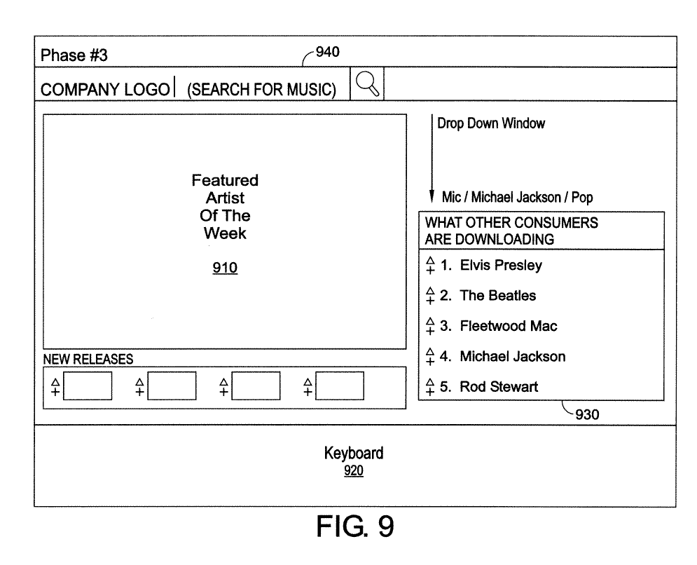

FIG. 9 presents the interactive screen for searching for music. Prominently displayed on the screen will be the featured artist of the week 910 which will be determined by the company operating the specific kiosk. Within proximity to that display will be new releases 920. The system will also determine what other customers are downloading 930 and will present these within the same screen as a drop-down menu. This allows a user to see what is most popular with the buying public. This may also be changed to correlate specifically with the specific type of music the customer is searching for once a search is performed. A box will contain a search function 940 which will allow the user to enter specific search terms, such as, but not limited to, an artist name, a song title, an album title, or a specific genre of music.

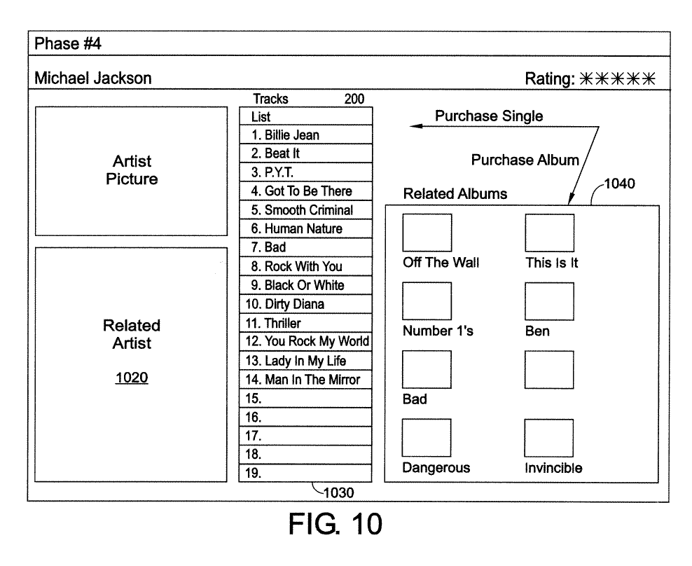

FIG. 10 presents the result of a search for a specific artist. The artist's picture 1010 will appear, as will artists in the same genre of music 1020. On this artist's page, a list of songs 1030 will be presented. Similarly, related albums 1040 can also be presented, for example other albums by the same artist or albums from related artists.

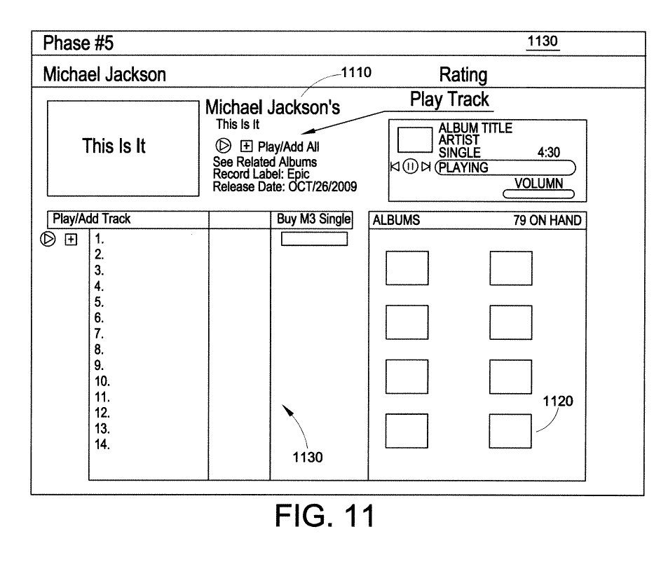

FIG. 11 presents an album specific search result. The artist 1110 is presented, as is a specific album by this artist. Adjacent to that would be albums by that specific artist and/or tracks on the specific album 1130 presented by the current screen.

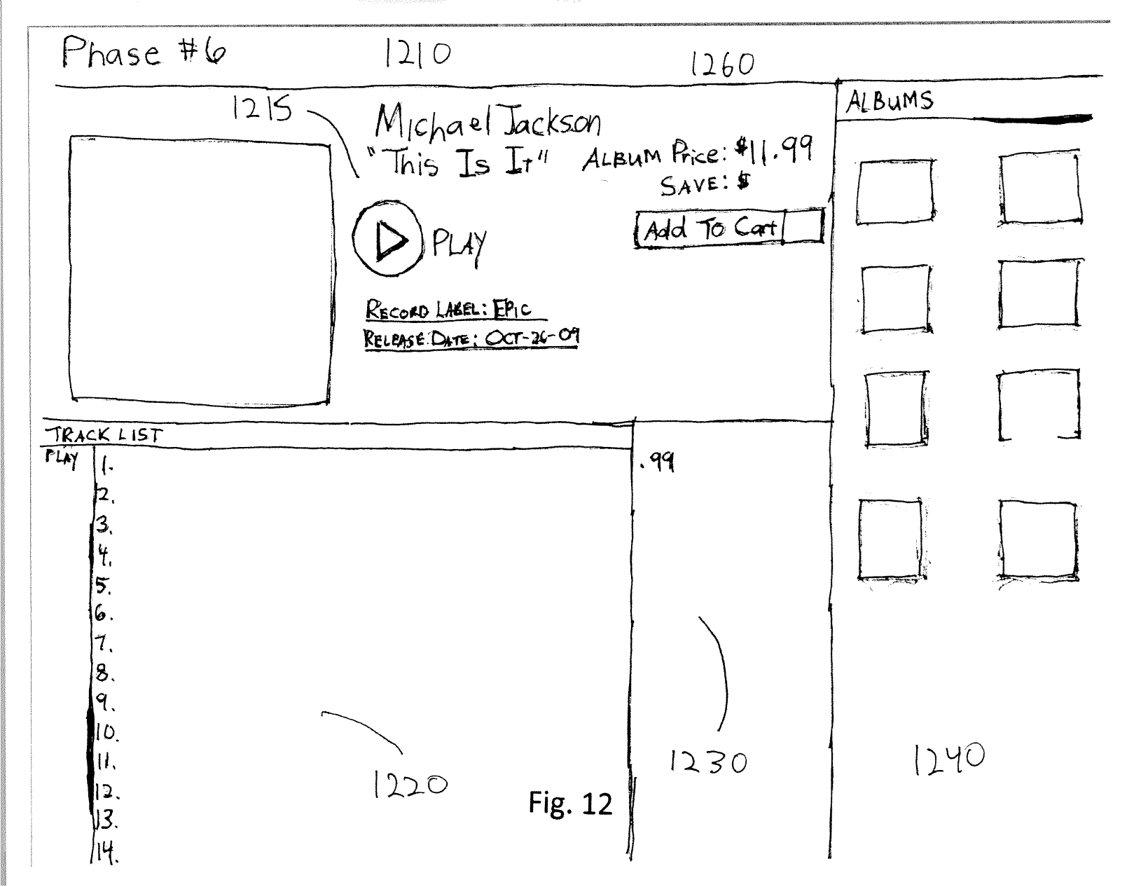

FIG. 12 presents only the songs on a specific album. This is the result of a search by a specific album title. In the present case, the artist 1210 will be presented and will allow a user to play 1215 a sample from this album. Samples that may be played include a specific song or song fragments from the specific album. The songs will be listed 1220 as a track list and accompanying the songs will be a price 1230 for each individual song. Similarly, the price of buying the entire album completely 1260 is also presented. Also presented are other albums by this artist 1240.

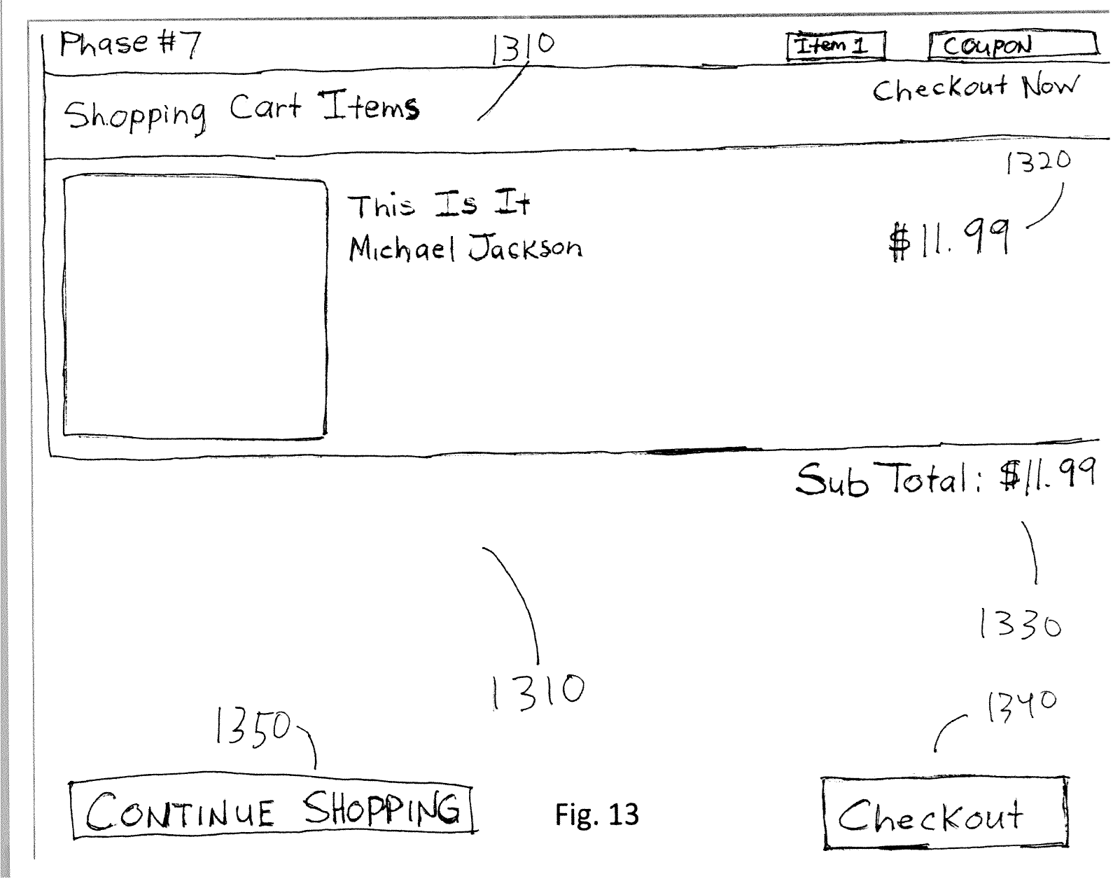

FIG. 13 presents the shopping cart which is a collection of items the user has selected for purchase. In this case, the specific album or song 1310 will be presented as will the price 1320 of the specific purchase. Below that will be a sub-total 1330 of all items the user has elected to purchase. The user will be given a choice to either check out 1340 (in which case the user will stop shopping and will be able to now make the final purchase) or the user will also be presented with an option to continue shopping 1350 (which will enable the user to make more purchases).

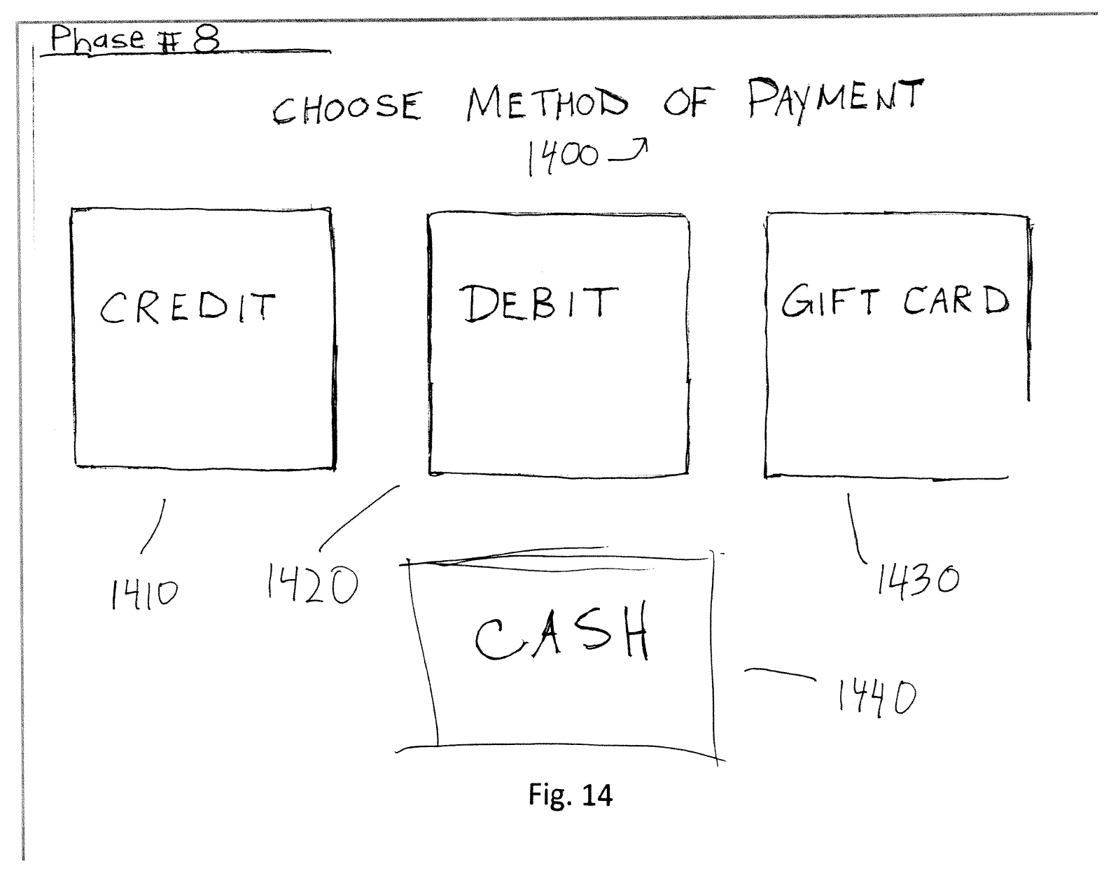

FIG. 14 presents a screen that allows the user to choose the specific type of means of payment the user wishes to use. The user may choose from a set, such as, but not limited to a credit card 1410, a debit 1420, a gift card 1430, or the user may insert cash 1440.

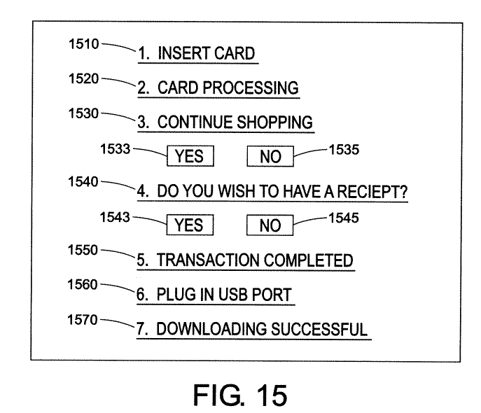

FIG. 15 presents a step-by-step process which will be used to prompt the user and guide the user through the specific shopping process. The user will be first prompted to insert card 1510 which will be the credit card, debit card, or any other type of payment. The user will then find a message stating the card is processing 1520. This will occur and the message will be displayed for the amount of time that it takes the payment to be processed. The user will then be prompted to have a choice to continue shopping 1530, to which the user may select a YES 1533 which will send the user back to the search feature from 1940. Alternately, the user may choose not to continue shopping 1535, in which case the payment screen 1400 will be displayed. It may also be that the shopping cart 1310 is displayed at this point. The user will then be prompted to make another selection, the selection being “do you wish to have a receipt?” 1540. If the user selects YES 1543, a receipt will be printed out in a hard copy paper format. If the user chooses NO 1545, a receipt will not be printed. The user is then informed that the transaction portion of the process has been completed 1550, and no more shopping or searching will be permitted. The user will then be prompted to plug in his device 1560 into which the music will be downloaded. This corresponds to the earlier choice 800 of which type of device the user would like to use. At the end, the user will be informed that the download has been performed successfully 1570. This will be the final step in the process to allow the user to know that the transaction has been completed and the music has been downloaded. At this point, the user may also be prompted to unplug the device used to download the music. Having fully completed the music selection, payment, and download, the introduction screen 710 will be displayed such that another user may repeat the process.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. An interactive digital content download kiosk, comprising:
an internal database of stored audio/video data;
a network interface for the transmission of data between the internal database and a remote server;
a user interface to request data from the internal database;
a payment means for receiving payments;
a downloading means to transfer data from the internal database and into an associated user device;
an administrator means to control access to the internal database;
a timer routine for scheduling kiosk activities;
a reporting routine for generating kiosk usage reports;
an advertising interface for the transmission of advertisements; and
a computer operable processor to operate the kiosk.

2. A system for managing a plurality of interactive digital content download kiosks, comprising:
a central computer database;
a plurality of kiosks, each kiosk comprising:
an internal database of stored audio/video data;
a network interface for the transmission of data between the internal database and a remote server;
a user interface to request data from the internal database;
a payment means for receiving payments;
a downloading means to transfer data from the internal database and into an associated user device;
an administrator means to control access to the internal database;
a timer routine for scheduling kiosk activities;
a reporting routine for generating kiosk usage reports;
an advertising interface for the transmission of advertisements; and
a computer operable processor to operate the kiosk; and
data connections from the central computer database to each kiosk.
